(19) United States
(12) Patent Application Publication
(10) Pub. No.: US 2006/0141327 A1
(43) Pub. Date: Jun. 29, 2006

(54) Electrically balanced fluid manifold assembly for an electrochemical fuel cell system

(76) Inventors: Rae Hartwell, Surrey (CA); Thian Lim, Delta (CA); Mark E. Reimer, Port Moody (CA); Robert H. Artibise, Vancouver (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/024,048

(22) Filed: Dec. 28, 2004

(51) Int. Cl. H01M 8/24

(52) U.S. Cl. 429/38

(57) ABSTRACT

An electrically balanced fluid manifold assembly for supplying a fluid to an electrochemical fuel cell system comprising at least two fuel cell stacks electrically connected in series, each fuel cell stack comprising an inlet fluid port and an outlet fluid port, the manifold assembly comprising: a primary inlet fluid line; a primary outlet fluid line; at least two branch inlet fluid lines, fluidly connecting the primary inlet fluid line to each inlet fluid port of the at least two fuel cell stacks; and at least two branch outlet fluid lines, fluidly connecting each outlet fluid port of the at least two fuel cell stacks to the primary outlet fluid line, wherein the branch inlet fluid lines and the branch outlet fluid lines are configured such that the electrical resistance is essentially the same between (a) each inlet fluid port of the at least two fuel cell stacks and the primary inlet fluid line, and (b) each outlet fluid port of the at least two fuel cell stacks and the primary outlet fluid line.

### BACKGROUND OF THE INVENTION

1. Field of the Invention

The present invention relates to electrochemical fuel cell systems, and, more particularly, to an electrically balanced fluid manifold assembly for an electrochemical fuel cell system.

2. Description of the Related Art

Electrochemical fuel cells convert reactants, namely fuel and oxidant, to generate electric power and reaction products. Electrochemical fuel cells generally employ an electrolyte disposed between two electrodes, namely a cathode and an anode. An electrocatalyst, disposed at the interfaces between the electrolyte and the electrodes, typically induces the desired electrochemical reactions at the electrodes. The location of the electrocatalyst generally defines the electrochemically active area of the fuel cell.

Polymer electrolyte membrane (PEM) fuel cells generally employ a membrane electrode assembly (MEA) comprising a solid polymer electrolyte or ion-exchange membrane disposed between two electrode layers comprising a porous, electrically conductive sheet material, such as carbon fiber paper or carbon cloth, as a fluid diffusion layer. In a typical MEA, the electrode layers provide structural support to the ion-exchange membrane, which is typically thin and flexible. The membrane is ion conductive (typically proton conductive), and also acts as a barrier for isolating the reactant streams from each other. Another function of the membrane is to act as an electrical insulator between the two electrode layers. A typical commercial PEM is a sulfonated perfluorocarbon membrane sold by E.I. Du Pont de Nemours and Company under the trade designation NAFION®.

As noted above, the MEA further comprises an electrocatalyst, typically comprising finely comminuted platinum particles disposed in a layer at each membrane/electrode layer interface, to induce the desired electrochemical reactions. The electrodes are electrically coupled to provide a path for conducting electrons between the electrodes through an external load.

In a fuel cell, the MEA is typically interposed between two electrically conductive separator plates that are substantially impermeable to the reactant fluid streams. The plates act as current collectors and provide support for the electrodes. To control the distribution of the reactant fluid streams to the electrochemically active area, the surfaces of the plates that face the MEA may have open-faced channels formed therein. Such channels define a flow field area that generally corresponds to the adjacent electrochemically active area. Such separator plates, which have reactant channels formed therein, are commonly known as flow field plates.

In a fuel cell stack, a plurality of fuel cells are connected together, typically in series, to increase the overall output power of the assembly. In such an arrangement, one side of a given separator plate may serve as an anode plate for one cell and the other side of the plate may serve as the cathode plate for the adjacent cell. In this arrangement, the plates may be referred to as bipolar plates.

The fuel fluid stream that is supplied to the anode typically comprises hydrogen. For example, the fuel fluid stream may be a gas such as substantially pure hydrogen or a reformate stream containing hydrogen. Alternatively, a liquid fuel stream such as aqueous methanol may be used. The oxidant fluid stream, which is supplied to the cathode, typically comprises oxygen, such as substantially pure oxygen, or a dilute oxygen stream such as air.

In a fuel cell stack, the reactant fluid streams are typically supplied and exhausted by supply and exhaust manifolds through manifold ports to the respective flow field areas and electrodes. These manifolds may be internal manifolds, which extend through aligned openings in the separator plates, or may comprise external or edge manifolds, attached to the edges of the separator plates.

In addition, further manifolds, manifold ports and channels may be provided for circulating a coolant fluid stream through the fuel cell stack to absorb heat generated by the exothermic fuel cell reactions. For example, in a typical fuel cell stack, a coolant fluid stream is circulated through interior passages or closed channels within each of the separator plates. However, contact between the coolant fluid stream and the electrically conductive separator plates may cause unwanted parasitic shunt currents to flow through the coolant. These leakage currents can lead to short circuiting, induce galvanic corrosion and electrolyze the coolant, thereby reducing system efficiency.

To date, efforts to minimize the amount of such leakage currents have focused on electrically insulating the coolant fluid streams flowing through the coolant manifolds, manifold ports and channels, and/or reducing the conductivity of the coolant fluid itself. For example, U.S. Pat. No. 6,773,841 discloses electrically floating the coolant inlet and outlet ports of a fuel cell stack or using insulated coolant ports at the manifold to increase overall network insulation resistance. However, such embodiments may lead to shock hazards as most of the coolant ports are made of conductive materials. Moreover, most of the non-metallic ports do not meet system reliability and robustness requirements. Alternatively, International Patent Application Publication No. WO 00/17951 discloses methods for keeping the conductivity of the coolant fluid low.

Accordingly, although there have been advances in the field, there remains a need in the art for improved systems and methods for minimizing the amount of leakage currents in fuel cell systems. The present invention addresses these needs and provides further related advantages.

### BRIEF SUMMARY OF THE INVENTION

In brief, the present invention is directed to an electrically balanced fluid manifold assembly for an electrochemical fuel cell system.

In one embodiment, the present invention provides an electrically balanced fluid manifold assembly for supplying a fluid to an electrochemical fuel cell system comprising at least two fuel cell stacks electrically connected in series, each fuel cell stack comprising an inlet fluid port and an outlet fluid port, the manifold assembly comprising: (1) a primary inlet fluid line; (2) a primary outlet fluid line; (3) at least two branch inlet fluid lines, fluidly connecting the primary inlet fluid line to each inlet fluid port of the at least two fuel cell stacks; and (4) at least two branch outlet fluid lines, fluidly connecting each outlet fluid port of the at least two fuel cell stacks to the primary outlet fluid line, wherein the branch inlet fluid lines and the branch outlet fluid lines are configured such that the electrical resistance is essentially the same between (a) each inlet fluid port of the at least two fuel cell stacks and the primary inlet fluid line, and (b) each outlet fluid port of the at least two fuel cell stacks and the primary outlet fluid line.

In a further embodiment of the fluid manifold assembly, the fuel cell system comprises two fuel cell stacks, the branch inlet fluid lines connect to the primary inlet fluid line at a point equidistant to the inlet fluid ports of the two fuel cell stacks, and the branch outlet fluid lines connect to the primary outlet fluid line at a point equidistant to the outlet fluid ports of the two fuel cell stacks.

In another further embodiment of the fluid manifold assembly, the fuel cell system comprises two fuel cell stacks, the branch inlet fluid lines connect to the primary inlet fluid line at a point not equidistant to the inlet fluid ports of the two fuel cell stacks, and the branch outlet fluid lines connect to the primary outlet fluid line at a point not equidistant to the outlet fluid ports of the two fuel cell stacks.

In another further embodiment of the fluid manifold assembly, the fuel cell system comprises four fuel cell stacks, the branch inlet fluid lines connect to the primary inlet fluid line at a point along the median between the inlet fluid ports of the four fuel cell stacks, and the branch outlet fluid lines connect to the primary outlet fluid line at a point along the median between the outlet fluid ports of the four fuel cell stacks.

In another further embodiment of the fluid manifold assembly, the fuel cell system comprises four fuel cell stacks, the branch inlet fluid lines connect to the primary inlet fluid line at a point not along the median between the inlet fluid ports of the four fuel cell stacks, and the branch outlet fluid lines connect to the primary outlet fluid line at a point not along the median between the outlet fluid ports of the four fuel cell stacks.

In a more specific embodiment of the fluid manifold assembly, the fluid is a coolant.

In another more specific embodiment of the fluid manifold assembly, the difference between the electrical resistances between: (a) each inlet fluid port of the at least two fuel cell stacks and the primary inlet fluid line; and (b) each outlet fluid port of the at least two fuel cell stacks and the primary outlet fluid line, is less than about 5% of the highest of the electrical resistances.

These and other aspects of the invention will be evident upon reference to the attached figures and following detailed description.

### BRIEF DESCRIPTION OF THE DRAWINGS

FIG. 1 is a schematic diagram of a fluid manifold assembly for supplying a fluid to an electrochemical fuel cell system.

FIG. 2 is an electrical schematic diagram of the fluid manifold assembly and fuel cell system of FIG. 1.

FIG. 3 is a top view of a representative fluid manifold assembly that is not electrically balanced.

FIG. 4 is a top view of a representative electrically balanced fluid manifold assembly of the present invention.

### DETAILED DESCRIPTION OF THE INVENTION

In the following description, certain specific details are set forth in order to provide a thorough understanding of various embodiments of the invention. However, one skill in the art will understand that the invention may be practiced without these details. In other instances, well known structures associated with fuel cell stacks have not been described in detail to avoid unnecessarily obscuring the descriptions of the embodiments of the invention. Unless the context requires otherwise, throughout the specification and claims which follow, the word “comprise” and variations thereof, such as “comprises” and “comprising” are to be construed in an open, inclusive sense, that is as “including but not limited to”.

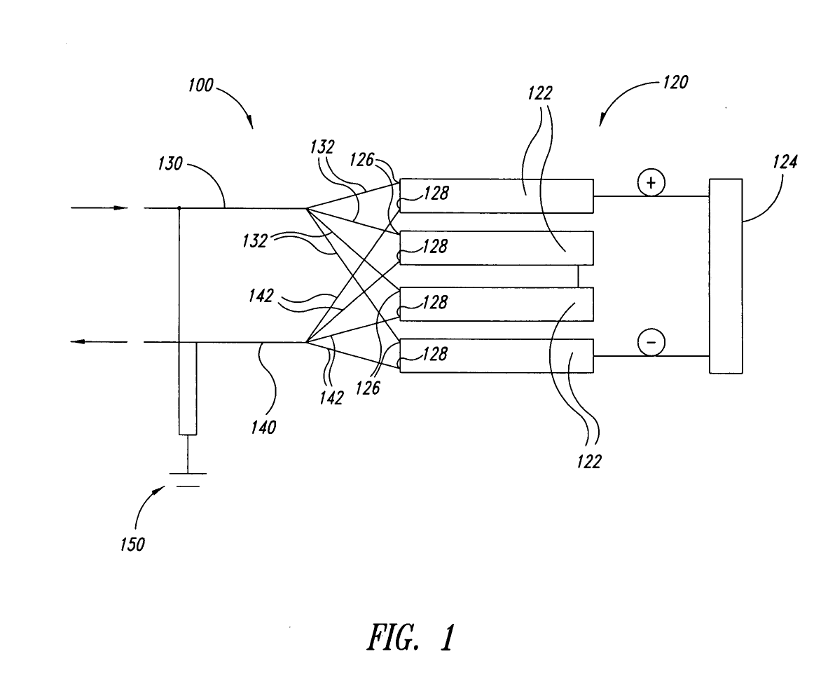

FIG. 1 is a schematic diagram of a fluid manifold assembly 100 for supplying a fluid to an electrochemical fuel cell system 120. The fluid supplied may be a reactant fluid (i.e., fuel or oxidant) or a coolant fluid. As shown, fuel cell system 120 comprises a plurality of fuel cell stacks (or fuel cell rows) 122 electrically connected in series to a high voltage load 124. In the illustrated embodiment, fuel cell system 120 comprises four fuel cell stacks 122, however, one of skill in the art will appreciate that, in other embodiments, fuel cell system 120 may comprise a fewer, or greater, number of fuel cell stacks 122. Each fuel cell stack 122 comprises an inlet fluid port 126 and an outlet fluid port 128.

As further shown in FIG. 1, fluid manifold assembly 100 comprises a primary inlet fluid line 130 and a primary outlet fluid line 140, both of which are grounded (by, for example, electrical connection to a vehicle chassis 150 when fuel cell system 120 and fluid manifold assembly 100 are employed in a vehicle). Fluid manifold assembly 100 further comprises a plurality of branch inlet fluid lines 132, fluidly connecting primary inlet fluid line 130 to each inlet fluid port 126 of the fuel cell stacks 122, and a plurality of branch outlet fluid lines 142, fluidly connecting each outlet fluid port 128 of the fuel cell stacks 122 to primary outlet fluid line 140. Although in the illustrated embodiment four branch inlet fluid lines 132 and four branch outlet fluid lines 142 are depicted, one of skill in the art will appreciate that, in other embodiments, fluid manifold assembly 100 may comprise a fewer, or greater, number of branch inlet and outlet fluid lines.

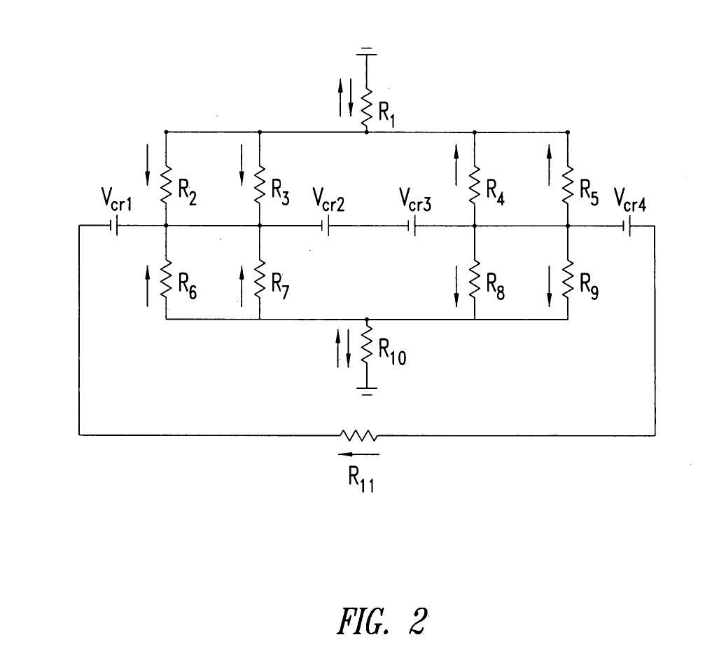

As noted previously, contact between the fluid circulated through fluid manifold assembly 100 and electrically conductive components of fuel cell system 120 (such as the separator plates (not specifically shown) in fuel cell stacks 122) may cause unwanted parasitic shunt currents (or leakage currents) to flow through the fluid and/or electrically conductive components of fluid manifold assembly 100. The flow of current through fluid manifold assembly 100 is illustrated in the following FIG. 2. As shown, current may flow in either direction through resistors R₁ and R₁₀ depending on the resistance of resistors R₂ through R₉.

FIG. 2 is an electrical schematic diagram of the fluid manifold assembly and fuel cell system of FIG. 1. The four fuel cell stacks 122 of FIG. 1 are represented in FIG. 2 by V_{cr1}, V_{cr2}, V_{cr3} and V_{cr4} (which denote the voltages of cell row 1, cell row 2, cell row 3 and cell row 4, respectively). High voltage load 124 of FIG. 1 is represented in FIG. 2 by resistor R₁₁. Primary inlet fluid line 130 and primary outlet fluid line 140 of FIG. 1 are represented in FIG. 2 by resistors R₁₀ and R₁. Branch inlet fluid lines 132 of FIG. 1 are represented in FIG. 2 by resistors R₆, R₇, R₈ and R₉, and branch outlet fluid lines 142 of FIG. 1 are represented in FIG. 2 by resistors R₂, R₃, R₄ and R₅. Furthermore, in FIG. 2, the direction of current flow through the fuel cell system is represented by the arrow adjacent to R₁₁, and the direction of leakage current flow through the fluid manifold assembly is represented by the arrows adjacent to R₁ through R₁₀.

To date, efforts to minimize the amount of leakage current have focused on electrically insulating the fluid flowing through the fluid manifold assembly and fuel cell system and/or reducing the conductivity of the fluid itself. However, it has now been found that the amount of leakage current may be reduced to a negligible amount by electrically balancing the fluid manifold assembly.

With reference to FIGS. 1 and 2, in a representative electrically balanced fluid manifold assembly of the present invention, the electrical resistance between each inlet fluid port 126 and the primary inlet fluid line 130, and each outlet fluid port 128 and the primary outlet fluid line 140, is essentially the same. More specifically, the values of R₂ through R₉ are essentially the same. As used herein, the phrase “essentially the same” means that the difference between the electrical resistances between each inlet fluid port 126 and the primary inlet fluid line 130, and each outlet fluid port 128 and the primary outlet fluid line 140, is less than about 5% of the highest of the electrical resistances.

In one embodiment, fluid manifold assembly 100 may be electrically balanced by arranging branch inlet fluid lines 132 and branch outlet fluid lines 142 such that branch inlet fluid lines 132 connect to primary inlet fluid line 130 at a point along the median between the inlet fluid ports 126 of the four fuel stacks 122 of fuel cell system 120, and branch outlet fluid lines 142 connect to primary outlet fluid line 140 at a point along the median between the outlet fluid ports 128 of the four fuel cell stacks 122. By making the path lengths between the primary fluid lines and the fluid ports equal, the resistance associated with such path lengths will be essentially the same (assuming all other aspects of the primary fluid lines being equal—e.g., line diameter, wall thickness, etc . . . ).

As one of skill in the art will appreciate, this approach is also applicable with fuel cell systems comprising a fewer, or greater, number of fuel cell stacks. For example, for a fuel cell system comprising two fuel cell stacks, the branch inlet fluid lines would be connected to the primary inlet fluid line at a point equidistant to the inlet fluid ports of the two fuel cell stacks, and the branch outlet fluid lines would be connected to the primary outlet fluid line at a point equidistant to the outlet fluid ports of the two fuel cell stacks.

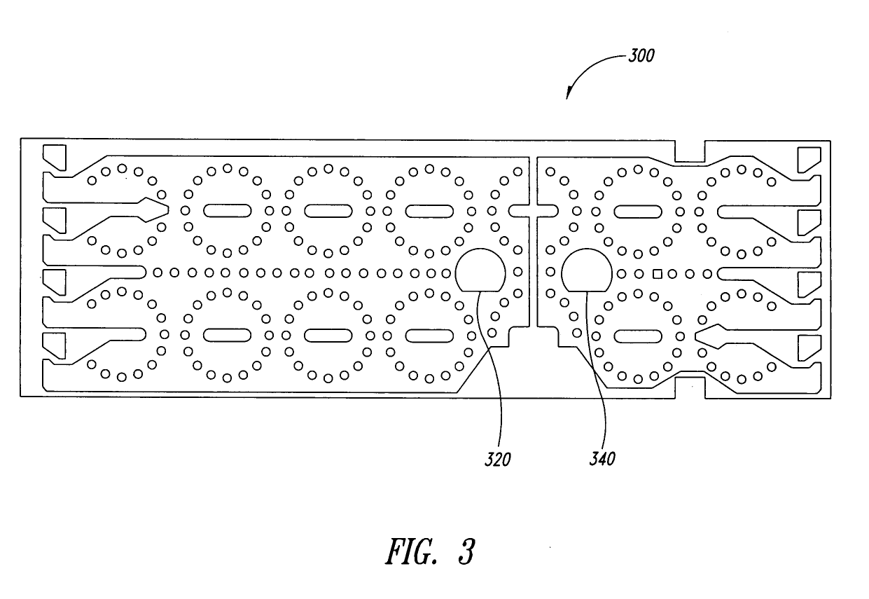

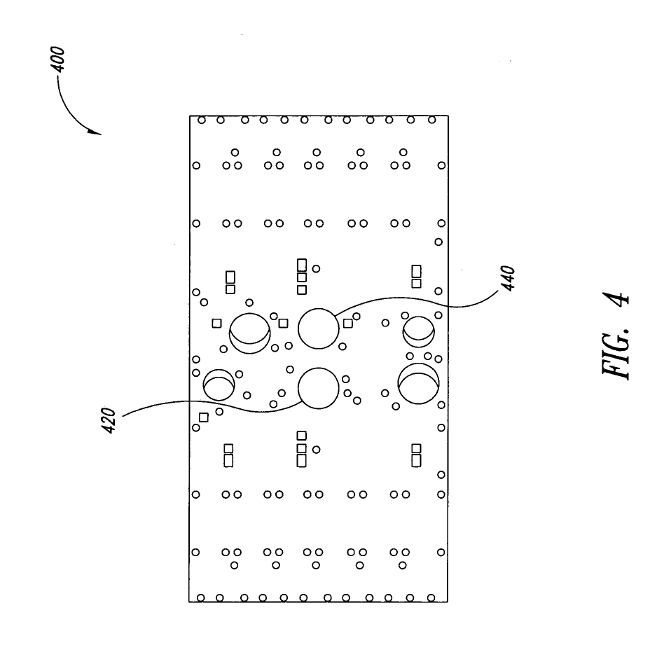

FIGS. 3 and 4 further illustrate the foregoing approach to electrically balancing a fluid manifold assembly. FIG. 3 is a top view of a representative fluid manifold assembly 300 that is not electrically balanced. In operation, a fluid flows from fluid inlet 320 through fluid flow channels (not specifically shown) to the left side of manifold 300, then to the right side of manifold 300, and then to fluid outlet 340. As shown in FIG. 3, the path from fluid inlet 320 and fluid outlet 340 to the left side of manifold 300 is longer than the path from fluid inlet 320 and fluid outlet 340 to the right side of manifold 300. Accordingly, the path resistance to the left side of manifold 300 will be greater than the path resistance to the right side of manifold 300. FIG. 4, on the other hand, is a top view of a representative electrically balanced fluid manifold assembly of the present invention. As shown in FIG. 4, fluid inlet 420 and fluid outlet 440 are positioned such that the path from fluid inlet 420 and fluid outlet 440 to the left side of manifold 400 is the same as the path from fluid inlet 420 and fluid outlet 440 to the right side of manifold 400, thereby resulting in equal path resistance.

Alternatively, in other embodiments, the branch fluid lines do not connect to the primary fluid lines at points along the median between, or equidistant to, the fluid ports of the fuel cell stacks, and fluid manifold assembly 100 is electrically balanced by other means, including modifying the size (e.g., diameter, thickness, length, etc . . . ) of the branch fluid lines and/or reconfiguring the VCR connections.

In addition to reducing the amount of leakage current through the fluid manifold assembly, the electrically balanced fluid manifold assemblies of the present invention also result in a much higher overall system isolation resistance as shown in the Examples below, thereby reducing arcing and electrical shock hazards.

The following examples have been included to illustrate different embodiments and aspects of the invention but should not be construed as limiting in any way.

### EXAMPLES

### Example 1

### Comparative Example

A fluid manifold assembly, having the configuration shown in FIGS. 1 and 2 and the electrical resistances shown in Table 1 below, was assembled and tested with a conventional automotive fuel cell stack. In this configuration, the resistances were balanced within the left hand side of the assembly, but were not balanced within the right hand side of the assembly. The amount of current flowing through each of the resistors was determined and is shown in Table 1 below. In addition, the overall system isolation resistance was determined to be 461 kohm. As shown in Table 1, this assembly resulted in a substantial amount of leakage current through R₁ and R₁₀.

TABLE 1

| | Resistance | Current |
|---|---|---|
| | (kohms) | (microamps, except where noted) |
| R₁ | 18 | 7.502 |
| R₂ | 5000 | 25 |
| R₃ | 5000 | 25 |
| R₄ | 4000 | 19 |
| R₅ | 3500 | 22 |
| R₆ | 5000 | 25 |
| R₇ | 5000 | 25 |
| R₈ | 3000 | 26 |
| R₉ | 2500 | 31 |
| R₁₀ | 18 | 7.5 |

### Example 2

### Comparative Example

A fluid manifold assembly, having the configuration shown in FIGS. 1-3 and the electrical resistances shown in Table 2 below, was assembled and tested with a conventional automotive fuel cell stack. In this configuration, the resistances were balanced within each of the left and right hand sides of the assembly (i.e., the resistance of R₂, R₃, R₆ and R₇ were equal, and the resistance of R₄, R₅, R₈ and R₉ were equal), however, the resistances between the left and right hand sides were not balanced (i.e., the resistances of assembly were not symmetrical between the left and right hand sides). The amount of current flowing through each of the resistors was determined and is shown in Table 2 below. In addition, the overall system isolation resistance was determined to be 375 kohms. As shown in Table 2, this assembly resulted in a small amount of leakage current through R₁ and R₁₀.

TABLE 2

| | Resistance | Current |
|---|---|---|
| | (kohms) | (microamps, except where noted) |
| R₁ | 18 | 1.2 × 10⁻²⁰ amps |
| R₂ | 5000 | 29 |
| R₃ | 5000 | 29 |
| R₄ | 2000 | 29 |
| R₅ | 2000 | 29 |
| R₆ | 5000 | 29 |
| R₇ | 5000 | 29 |
| R₈ | 2000 | 29 |
| R₉ | 2000 | 29 |
| R₁₀ | 18 | 2.5 × 10⁻²⁰ amps |

### Example 3

### Electrically Balanced Fluid Manifold Assembly

An electrically balanced fluid manifold assembly, having the configuration shown in FIGS. 1, 2 and 4 and the electrical resistances shown in Table 3 below, was assembled and tested with a conventional automotive fuel cell stack. In this configuration, all of the resistances were balanced within, and between, each of the left and right hand sides of the assembly (i.e., the resistance of R₂-R₉ were equal). The amount of current flowing through each of the resistors was determined and is shown in Table 3 below. In addition, the overall system isolation resistance was determined to be 400 kohm, which is desirably higher than the overall system isolation resistance of the configuration of Comparative Example 2. In addition, as shown in Table 3, this assembly results in no leakage current through R₁ and R₁₀.

TABLE 3

| | Resistance | Current |
|---|---|---|
| | (kohms) | (microamps, except where noted) |
| R₁ | 18 | 0 |
| R₂ | 3200 | 31 |
| R₃ | 3200 | 31 |
| R₄ | 3200 | 31 |
| R₅ | 3200 | 31 |
| R₆ | 3200 | 31 |
| R₇ | 3200 | 31 |
| R₈ | 3200 | 31 |
| R₉ | 3200 | 31 |
| R₁₀ | 18 | 0 |

From the foregoing, it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. An electrically balanced fluid manifold assembly for supplying a fluid to an electrochemical fuel cell system comprising at least two fuel cell stacks electrically connected in series, each fuel cell stack comprising an inlet fluid port and an outlet fluid port, the manifold assembly comprising:
a primary inlet fluid line;
a primary outlet fluid line;
at least two branch inlet fluid lines, fluidly connecting the primary inlet fluid line to each inlet fluid port of the at least two fuel cell stacks; and
at least two branch outlet fluid lines, fluidly connecting each outlet fluid port of the at least two fuel cell stacks to the primary outlet fluid line,
wherein the branch inlet fluid lines and the branch outlet fluid lines are configured such that the electrical resistance is essentially the same between (a) each inlet fluid port of the at least two fuel cell stacks and the primary inlet fluid line, and (b) each outlet fluid port of the at least two fuel cell stacks and the primary outlet fluid line.

2. The fluid manifold assembly of claim 1 wherein:
the fuel cell system comprises two fuel cell stacks;
the branch inlet fluid lines connect to the primary inlet fluid line at a point equidistant to the inlet fluid ports of the two fuel cell stacks; and
the branch outlet fluid lines connect to the primary outlet fluid line at a point equidistant to the outlet fluid ports of the two fuel cell stacks.

3. The fluid manifold assembly of claim 1 wherein:
the fuel cell system comprises two fuel cell stacks;
the branch inlet fluid lines connect to the primary inlet fluid line at a point not equidistant to the inlet fluid ports of the two fuel cell stacks; and
the branch outlet fluid lines connect to the primary outlet fluid line at a point not equidistant to the outlet fluid ports of the two fuel cell stacks.

4. The fluid manifold assembly of claim 1 wherein:
the fuel cell system comprises four fuel cell stacks;
the branch inlet fluid lines connect to the primary inlet fluid line at a point along the median between the inlet fluid ports of the four fuel cell stacks; and
the branch outlet fluid lines connect to the primary outlet fluid line at a point along the median between the outlet fluid ports of the four fuel cell stacks.

5. The fluid manifold assembly of claim 1 wherein:
the fuel cell system comprises four fuel cell stacks;
the branch inlet fluid lines connect to the primary inlet fluid line at a point not along the median between the inlet fluid ports of the four fuel cell stacks; and
the branch outlet fluid lines connect to the primary outlet fluid line at a point not along the median between the outlet fluid ports of the four fuel cell stacks.

6. The fluid manifold assembly of claim 1 wherein the fluid is a coolant.

7. The fluid manifold assembly of claim 1 wherein the difference between the electrical resistances between:
(a) each inlet fluid port of the at least two fuel cell stacks and the primary inlet fluid line; and
(b) each outlet fluid port of the at least two fuel cell stacks and the primary outlet fluid line,
is less than about 5% of the highest of the electrical resistances.
